(19) United States
(12) Patent Application Publication
(10) Pub. No.: US 2024/0249044 A1
(43) Pub. Date: Jul. 25, 2024

(54) MACHINE LEARNING MODELS FOR ELECTRICAL POWER SIMULATIONS

(71) Applicant: X Development LLC, Mountain View, CA (US)

(72) Inventors: Ananya Gupta, San Francisco, CA (US); Mike Miao He, Mountain View, CA (US); Xinyue Li, San Mateo, CA (US); Phillip Ellsworth Stahlfeld, Mountain View, CA (US)

(21) Appl. No.: 18/099,154

(22) Filed: Jan. 19, 2023

(51) Int. Cl. G06F 30/27

(52) U.S. Cl. CPC G06F 30/27; G06F 2113/04

(57) ABSTRACT

In one aspect, there is provided a method for training a machine learning model to process a graph that represents an electrical system to infer, from the graph, one or more unknown electrical values within the electrical system. In particular, the method includes: obtaining data defining multiple graphs, each graph representing a respective electrical system topology, obtaining, for each electrical system topology and from an electrical simulation system, simulation results indicating an electrical behavior of the respective electrical system topology, and training the machine learning model to predict electrical behaviors of electrical systems including by applying data defining each graph as input to the machine learning model to obtain respective output inferences and adjusting machine learning model parameters responsive to comparisons between the output inferences with simulation results of corresponding electrical system topologies.

### TECHNICAL FIELD

This specification relates to applying machine learning models for electrical power simulations.

### BACKGROUND

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

Electrical power simulation engines are useful tools for simulating and analyzing operations of electrical systems (e.g., power grids) under various operating conditions. These tools are often employed for planning future expansions of power systems and operational analysis of existing power systems by utility companies and academic researchers. Power flow simulation engines can simulate electrical behaviors of power systems by focusing on various operational parameters, such as voltages, voltage angles, real power, and reactive power.

However, simulations of electric grids can be prohibitively computationally expensive due to complex interactions between large numbers of different components of the system. Such simulations often rely on electric grid models that are used to evaluate and predict operations and potential faults in an electric grid. However, some electric grid models are incomplete or inaccurate, and any small error in the model can lead to inadequate simulation results. Physics-based analytical solvers often will not converge to adequate solutions if there are inaccuracies in the electrical grid model. Accordingly, there exists a growing need for holistic techniques for performing electrical power grid simulations of complex electrical systems.

### SUMMARY

This specification describes systems and methods for simulating electrical behaviors of an electrical system. Throughout this specification, an “electrical system” can generally refer to any appropriate type of interconnected network for electricity/power delivery. As a particular example, the electrical system can be an electrical power grid, e.g., a network of electrical buses connected through wires or other types of conductors. Generally, the electrical system can include any appropriate number of buses connected by any appropriate number of conductors and in any appropriate combination, e.g., 2 buses, 10 buses, 100 buses, 1000 buses, 5000 buses, or any other appropriate number of buses. The structure, or connectivity, of the electrical system can be referred to as a “topology” of the electrical system. An “electrical behavior” of an electrical system can generally refer to any appropriate physical aspect of the functioning of the electrical system, e.g., power flow through the system.

The systems and methods described in this specification can train a machine learning model to predict one or more unknown electrical values associated with the electrical system, e.g., voltage magnitudes and angles of one or more of the buses, currents flowing through one or more of the conductors, or any other appropriate electrical values. Throughout this specification, an “unknown” electrical quantity can generally refer to an electrical value that is incorrect, or missing, in an electrical model of the electrical system. For example, if the electrical system is a power grid, data defining the power grid may include one or more buses having missing, or incorrect, voltage values, and/or one or more conductors having missing, or incorrect, current values. In some cases, the systems and methods described in this specification can train the machine learning model using training data that is generated by an electrical simulation system, e.g., a ground-truth electrical simulation system.

The systems and methods described in this specification can use the trained machine learning model to make predictions of one or more unknown electrical values associated with the electrical system. Then, the systems and methods described in this specification can compile predictions made by the trained machine learning model with simulations performed by other electrical simulation systems in order to complete missing, or incorrect, data in the electrical model.

According to a first aspect, there is provided a method for training a machine learning model, the method including: training the machine learning model to process a graph that represents an electrical system to infer, from the graph, one or more unknown electrical values within the electrical system. This includes: obtaining data defining a plurality of graphs, each graph representing a respective electrical system topology; obtaining, for each electrical system topology and from an electrical simulation system, simulation results indicating an electrical behavior of the respective electrical system topology; and training the machine learning model to predict electrical behaviors of electrical systems including by applying data defining each graph as input to the machine learning model to obtain respective output inferences and adjusting parameters of the machine learning model responsive to comparisons between the output inferences with simulation results of corresponding electrical system topologies.

In some implementations, the simulation results indicating the electrical behavior of the respective electrical system topology are generated using a ground-truth electrical simulation system.

In some implementations, data defining the plurality of graphs includes one or more unknown electrical values within the electrical system.

In some implementations, the electrical system represented by the graph is a real-world electrical power grid, and wherein the electrical system topology is a topology of the real-world electrical power grid.

In some implementations, the graph that represents the electrical system comprises a plurality of nodes and a plurality of edges, wherein: (i) each node represents a bus in the electrical system and is associated with respective node features, and (ii) edges in the graph are defined by a nodal admittance matrix that corresponds to a number of buses in the electrical system, each edge in the graph connects a pair of nodes in the graph, is associated with respective edge features, and represents a conductor in the electrical system that connects a pair of buses represented by the pair of nodes.

In some implementations, obtaining data defining a plurality of graphs, each graph representing a respective electrical system topology comprises, for each graph of the plurality of graphs: obtaining data defining an admittance matrix; and assigning an edge between a pair of nodes in the graph based on values specified by the admittance matrix.

In some implementations, one or more of the nodes in the graph represent different bus types in the electrical system, and wherein the bus types include: a swing bus, a generator, and a load.

In some implementations, the node features associated with each node that represents a respective bus in the electrical system include one or more of: a voltage magnitude, a voltage angle, an active power, and a real power, and wherein the edge features associated with each edge include a current associated with the conductor in the electrical system represented by the edge.

In some implementations, the machine learning model is a graph neural network, and wherein training the machine learning model to predict the electrical behaviors of the electrical system by applying the data defining each graph as the input to the machine learning model to obtain the respective output inferences comprises, for each graph representing the respective electrical system topology: updating the graph at each of one or more update iterations, comprising, at each update iteration: processing data defining the graph using the graph neural network in accordance with a set of graph neural network parameters to update a current node representation of each node in the graph and a current edge representation of each edge in the graph.

In some implementations, the method further includes after the updating, processing the respective current node representation for each node in the graph to generate a respective final feature corresponding to each node in the graph, and processing the current edge representation for each edge in the graph to generate a respective final feature corresponding to each edge in the graph; and based on the respective final feature corresponding to each node in the graph and the respective final feature corresponding to each edge in the graph, generating the respective output inferences that represent one or more unknown electrical values within the electrical system.

According to a second aspect, there is provided a system including: one or more computers; and one or more storage devices communicatively coupled to the one or more computers, where the one or more storage devices store instructions that, when executed by the one or more computers, cause the one or more computers to perform the operations of the respective method of any preceding aspect.

According to a third aspect, there are provided one or more non-transitory computer storage media storing instructions that when executed by one or more computers cause the one or more computers to perform the operations of the respective method of any preceding aspect.

Particular embodiments of the subject matter described in this specification can be implemented so as to realize one or more of the following advantages.

The systems and methods described in this specification can perform simulations of electrical behaviors of an electrical system without relying on a perfect model of the electrical system. In particular, the systems and methods described in this specification can train a machine learning model using representations of different electrical system topologies. After training, the machine learning model can generalize to previously-unseen electrical system topologies and approximate power flow solutions even if the model of the electrical system includes inaccurate, or incorrect, data. In this manner, the systems and methods described in this specification can enable simulations of electrical behaviors of electrical systems that may otherwise be difficult, or impossible, to perform using, e.g., physics-based analytical solvers that often will not converge to adequate solutions if there are inaccuracies in the electrical system model.

The systems and methods described in this specification can train the machine learning model, e.g., a graph neural network, to efficiently mimic Newton-Raphson method in power flow simulations by using the machine learning model to make predictions of the electrical behavior of the system at each of multiple time steps. These predictions can be compiled with simulation results of existing power flow simulation models to improve the accuracy of the simulations. Because machine learning models such as graph neural networks are significantly more efficient and easier to parallelize, this can not only improve the accuracy of overall power flow simulations, but also significantly reduce the consumption of computational resources (e.g., memory and computing power).

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example electrical simulation system.

FIG. 2 is a flow diagram of an example process for training a machine learning model to predict electrical behaviors of an electrical system.

FIG. 3 is a flow diagram of an example process for performing simulations of electrical behaviors of an electrical system.

FIG. 4 is a block diagram of an example computer system.

Like reference numbers and designations in the various drawings indicate like elements.

### DETAILED DESCRIPTION

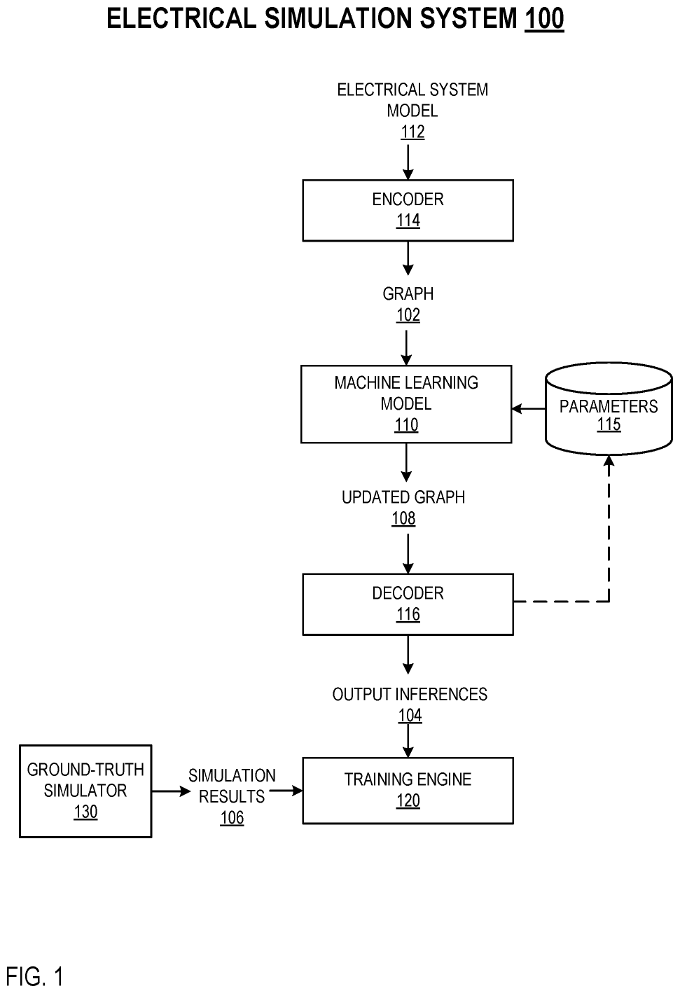

FIG. 1 illustrates an example electrical simulation system 100. The electrical simulation system 100 is an example of a system implemented as computer programs on one or more computers in one or more locations in which the systems, components, and techniques described below are implemented.

The electrical simulation system 100 can train a machine learning model 110 to predict electrical behaviors of an electrical system, e.g., to predict one or more electrical values associated with the electrical system. Generally, the electrical system can be any appropriate type of electrical system, e.g., an electrical power grid. In particular, the electrical simulation system 100 can train the machine learning model 110 by using it to process a graph 102 that represents the electrical system and generate output inferences 104 that predict one or more electrical values associated with the electrical system.

The electrical simulation system 100 can obtain the graph 102 that represents the electrical system in any variety of ways. In one example, the graph 102 can be obtained from an electrical system model 112, e.g., a model that specifies various electrical components of the electrical system. As a particular example, as described in more detail below, the system 100 can include an encoder 114 (e.g., an encoder neural network) that can process the electrical system model 112 of the electrical system and generate data defining the graph 102. In another particular example, the system 100 can obtain data defining graph 102 from a software application that is configured to generate graph representations of electrical systems from electrical system models.

Generally, the electrical system model 112 can specify various electrical components of the electrical system, and values for one or more features associated with these components. For example, the electrical system model can specify different types of buses included in the electrical system, e.g., a swing bus, a generator bus, and a load bus. Each bus can be associated with a set of variables, or features, e.g., real power (P), active power (Q), voltage (V), and voltage angle (A). In some cases, as described in more detail below, the values of these variables can be obtained from simulation results 106 of a ground-truth simulator 130 (e.g., form a powerflow simulation). In some cases, the electrical system model 112 of the electrical system can specify values for these variables. Generally, the values of these variables of the electrical system can be obtained in any appropriate manner.

In some cases, the electrical simulation system 100 can use, e.g., a model converter to convert the (e.g., incomplete) electrical system model 112 into the graph 102. For example, a model file of a neighborhood in a geographical region with several houses, transformers, and other components can be converted into nodes. In such cases, each node can represent a component from the aerial image to which wires or power lines are or should be connected, e.g., houses, transformers, substations, and any other electrical load or generator in the aerial image can be represented by a node. The connecting wires between components can become edges between pairs of nodes in the graph 102. In some cases, the model converter can also convert additional data representing how the nodes are connected into the nodes in the graph 102, e.g., metadata such as electric component properties or power line properties associated with each node and/or edge in the graph 102. Such metadata can include, but is not limited, to geographic locations of each component, the type of electrical component, power characteristics, relative distances between nodes, length of power lines, characteristics of the power lines (e.g., gauge wire used, voltage, current ratings), or a combination thereof. In some cases, the additional data can further include constraint data such as, e.g., physical distance between different components, electrical feeder information, and any other appropriate type of constraints. Generally, this type of data can provide further constraints on the limits or capabilities of the nodes and provide contextual data that enables the generation of the graph 102.

In some cases, each type of bus in the electrical system model 112 can be associated with known and unknown values of one or more of these variables. For example, the swing bus can be associated with known values of voltage and voltage angle, but unknown values of active power and real power. The generator bus can be associated with known values of real power and voltage, but unknown values of active power and voltage angle. Similarly, the load bus can be associated with known values of real power and active power, but unknown values of voltage and voltage angle. In some cases, the electrical system model can additionally specify various types of conductors included in the electrical system, and values of variables, or features, associated with the conductors, e.g., known or unknown values of current associated with the respective conductor. In some cases, if values for one or more components of the electrical system are not specified in the electrical system model (e.g., are unknown), the electrical simulation system 100 can randomly initialize these values. In some cases, the system 100 can initialize the values based on the simulation performed by the ground-truth simulator 130. In some cases, the electrical system model can represent a real-world electrical system, e.g., a real-world power grid.

In some implementations, the electrical system represented by the electrical system model can include different types of equipment (e.g., buses, transformers, conductors, and any other appropriate type of equipment) with different voltage and power levels that are connected together. In such cases, the electrical system model can specify values of one or more features, or variables, associated with components of the electrical system in “per-unit” representation, which is a representation that allows to absorb large differences between different values into base relationships. Specifically, the per-unit representation of value for a feature, or variable, can be defined as follows:

$$p . u . value = \frac{A ctual value in any unit}{Base or reference value in the same unit} \qquad ( 1 )$$

The base or reference value in equation (1) can be, e.g., equipment rating, e.g., nominal voltage, rated power, or any other appropriate equipment rating. By normalizing values of features, or variables, associated with components of the electrical system using equation (1), numerical stability of simulations performed by the electrical simulation system 100 can be significantly improved.

As described above, in one example, the electrical simulation system 100 can include an encoder (e.g., an encoder neural network) that can process the electrical system model to generate data defining the graph 102. Generally, a “graph” can refer to a data structure that includes multiple nodes and edges, where each edge connects a pair of nodes. The encoder can process the electrical system model that represents the electrical system and assign a node in the graph 102 to each of the buses in the electrical system, and instantiate an edge between a pair of nodes in the graph 102 for each conductor of the electrical system. Generally, nodes and edges in the graph 102 can also represent any other appropriate electrical components of the electrical system.

The graph 102 can represent an architecture, a connectivity, or a topology, of the electrical system. In some cases, data defining the electrical system model can include an array of numerical values (e.g., an admittance or impedance matrix) with a number of rows and columns equal to the number of nodes in the graph 102, e.g., equal to the number of buses in the electrical system. For example, if the electrical system includes N buses, the graph 102 can be represented by an N×N matrix, where the component of the matrix at position (i,j) can have value representing the admittance or impedance between two respective nodes. The encoder can form the graph representation of the electrical system model based on data included in the admittance or impedance matrix. For example, the encoder 114 can identify electrical connections between respective nodes based on the values in the admittance/impedance matrix. The encoder 114 can infer that an electrical connection exists between a pair of nodes in an admittance matrix when the component of the matrix at position (i,j) (representing the node pair) is relatively high (e.g., greater than a threshold or median value) or in an impedance matrix when the component of the matrix is relatively low (e.g., near zero). When the encoder 114 infers that two nodes are electrically connected, the encoder 114 connects those nodes with an edge. In some implementations, the edge can be assigned the admittance or impedance value from the matrix.

The graph 102 can also be represented by an N×N matrix, where edges connecting node pairs are represented by values of the matrix at position (i,j) can have value, e.g., 1 if the graph 102 includes an edge pointing from node i to node j, and value 0 otherwise. In some cases, data defining the graph 102 can include a sparse matrix, e.g., a matrix that includes more than a threshold number of elements having a value of zero.

As described above, the encoder can process the electrical system model and assign nodes and edges in the graph 102 to the components of the electrical system specified by the model. The electrical system model can further specify values for variables, or features, associated with the electrical components of the electrical system represented by the model. In some cases, in addition to assigning nodes and edges in the graph 102, the encoder can process the electrical model to generate encoded representations of these variables, or features. Generally, an “encoded representation” can refer to an ordered collection of numerical values, e.g., a vector or a matrix of numerical values. For example, the encoder can process one or more features (e.g., real power, reactive power, etc.) associated with a bus represented by the node in the graph 102, and generate an encoded representation of these features. Similarly, the encoder can process one or more features (e.g., current) associated with a conductor represented by an edge in the graph 102, and generate an encoded representation of these features. However, the encoded representations of features associated with components of the electrical system can be obtained in any other appropriate manner.

In some cases, the electrical system model that represents the electrical system can further specify one or more global features of the electrical system, a frequency of the electrical system, or any other appropriate feature. The encoder can process the global features specified by the electrical model and generate an encoded representation of the global features. In some cases, the encoder can concatenate the encoded representations of the global features with the encoded representations of the features, or variables, associated with the electrical components of the electrical system.

In this manner, the encoder of the electrical simulation system 100 can generate data defining the graph 102 that represents the electrical system specified by the electrical system model. Data defining the graph 102 can generally include multiple nodes and edges, encoded representations of features of electrical components represented by the nodes and edges and, optionally, encoded representations of global features of the electrical system.

As described above, the electrical simulation system 100 can train the machine learning model 110 to process data defining the graph 102 that represents the electrical system and generate output inferences 104 that predict one or more electrical values associated with the electrical system. This is described in more detail next.

In some implementations, the machine learning model 110 can be a graph neural network, e.g., a neural network having one or more graph neural network layers. Generally, the machine learning model 110 can have any appropriate architecture, e.g., it can include any appropriate type of neural network layers (e.g., convolutional layers, fully connected layers, recurrent layers, attention layers, etc.) in any appropriate numbers (e.g., 2 layers, 5 layers, or 10 layers) and connected in any appropriate configuration (e.g., as a linear sequence of layers). The machine learning model 110 can be configured to process data defining the graph 102 to generate the output inferences 104, e.g., predicted values of one or more features, or variables, associated with the components of the electrical system.

Specifically, the machine learning model 110 can be configured to update the graph 102 over a number of internal update iterations. “Updating” a graph can refer to, at each update iteration, performing a step of message-passing (e.g., a step of propagation of information) between the nodes and edges included in the graph 102 by, e.g., updating the node and/or edge representations for some or all nodes and edges in the graph 102 based on node and/or edge representations of neighboring nodes in the graph 102. During the updating process, the machine learning model leaves the topology (e.g., the connectivity) of the graph unchanged. In this way, at each update iteration, the machine learning model 110 can simulate interactions between various electrical components of the electrical system represented by the graph 102. The number of internal update iterations can be, e.g., 1, 10, 100, or any other appropriate number, and can be a predetermined hyper-parameter of the machine learning model 110.

A final update iteration of the machine learning model 110 can generate final updated representations of nodes and edges in the graph 102. The machine learning model 110 can process the final updated representations of nodes and edges in the graph 102 to generate the output inferences 104 that can include predicted values for features, or variables, associated with various electrical components of the electrical system. Specifically, in some cases, the machine learning model 110 can include a decoder 116 (e.g., a decoder neural network) that can decode predicted values from final updated node and edge representations.

For example, the decoder 116 can process updated representation of each node in the graph 102 (e.g., generated after final update iteration of the machine learning model 110) to generate predicted values for one or more of: real power (P), active power (Q), voltage (V), and voltage angle (A), associated with the bus represented by the node in the graph 102. As another example, the decoder 116 can process updated representation of each edge in the graph (e.g., generated after final update iteration of the machine learning model 110) to generate predicted values for, e.g., current associated with the conductor represented by the edge in the graph 102. In some cases, the decoder 116 can also process one or more final updated representations of one or more nodes and edges in the graph 102 to generate a predicted value for one or more global features of the electrical system represented by the graph 102, e.g., a predicted value for the frequency of the electrical system.

As described above, the electrical simulation system 100 can train the machine learning model 110 based on the output inferences 104 using: (i) a training engine 120 and (ii) an ground-truth simulator 130, each of which is described in more detail next.

The training engine 120 can use the output inferences 104 generated by the machine learning model 110 to train the machine learning model 110. Specifically, the training engine 120 can use the machine learning model 110 to generate respective output inferences 104 (e.g., as described above) for a set of graphs, each graph 102 in the set of graphs representing a different electrical system topology. For example, each graph 102 can represent an electrical system having different numbers of electrical buses, different types of electrical buses, and/or different number of conductors in various combinations.

The training engine 120 can train the machine learning model 110 by using any appropriate training technique, e.g., a supervised learning technique, on a set of training data. The training data can include a set of training examples, where each training example can specify: (i) a training input that can be processed by the machine learning model 110, and (ii) a target output that should be generated by the machine learning model 110 by processing the training input. Each training input can include a graph 102 representing a different electrical system topology, e.g., as described above. The training engine 120 can obtain the target outputs from a ground-truth simulator 130. The ground-truth simulator 130 can be, e.g., any appropriate ground-truth simulation system that is configured to perform simulations of different electrical system topologies and generate corresponding simulation results 106. The simulation results 106 can include, e.g., values for one or more variables, or features, of electrical components included in the electrical system.

At each training iteration, the training engine 120 can sample a batch of one or more training examples from the training data and provide them to the machine learning model 110 that can process the training inputs specified in the training examples to generate corresponding outputs. The training engine 120 can evaluate an objective function that measures a similarity between: (i) the target outputs specified by the training examples (e.g., simulation results 106 of the ground-truth simulator 130), and (ii) the outputs generated by the machine learning model (e.g., the output inferences 104). The objective function can be any appropriate objective function, e.g., a cross-entropy or squared-error objective function. The training engine 120 can determine gradients of the objective function, e.g., using backpropagation techniques, and can update the parameter values 115 of the machine learning model 110 using the gradients, e.g., using any appropriate gradient descent optimization algorithm, e.g., Adam.

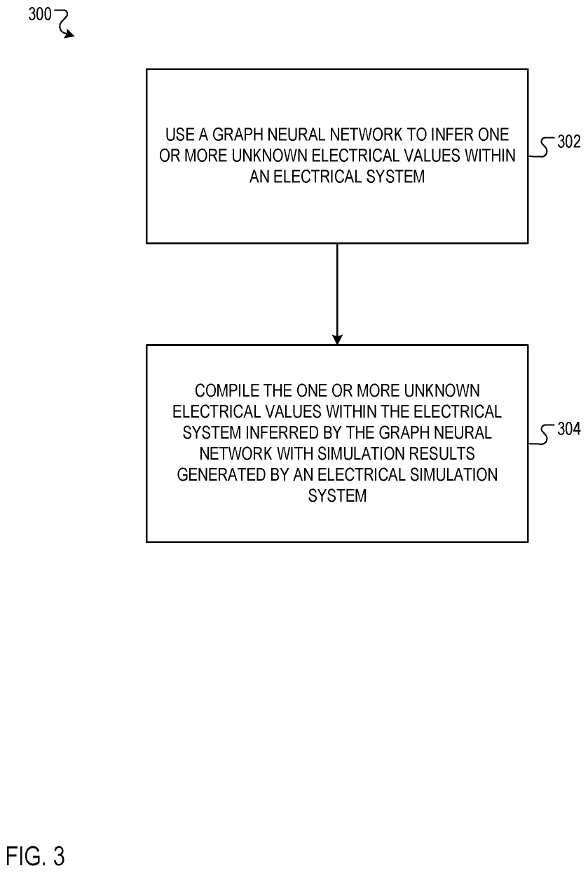

After training the machine learning model 110 using graphs that represent various electrical system topologies, the electrical simulation system 100 can use the machine learning model 110 to generate output inferences 104 for any electrical system topology, e.g., for electrical systems having any number of electrical components connected in any appropriate configuration. Furthermore, the electrical simulation system 100 can use the trained machine learning model 110 to generate output inferences 104 even for electrical system models that include missing, unknown, or incomplete data, which may not otherwise be possible using conventional physics-based analytical solvers that often will not converge to adequate solutions if there are inaccuracies in the electrical system model. In some cases, the electrical simulation system 100 can compile the output inferences 104 generated by the trained machine learning model 110 with simulation results of other simulation models in order to improve the accuracy of their simulations. This is described in more detail below with reference to FIG. 3.

An example process for training the machine learning model 110 to predict electrical behaviors of the electrical system is described in more detail next.

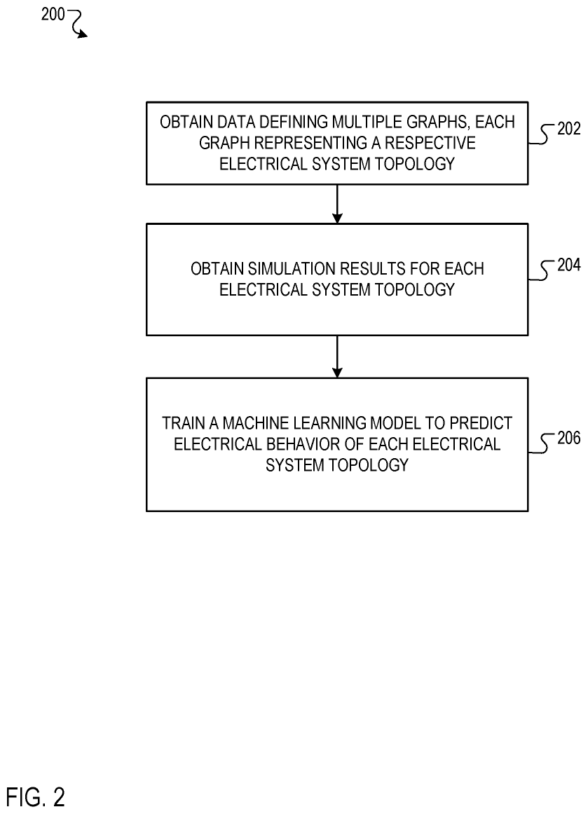

FIG. 2 is a flow diagram of an example process 200 for training a machine learning model (e.g., the machine learning model 110 in FIG. 1) to predict electrical behaviors of an electrical system. For convenience, the process 200 is described as being performed by a system of one or more computers located in one or more locations, e.g., the electrical simulation system 100 in FIG. 1.

The system trains the machine learning model to process a graph that represents an electrical system to infer, from the graph, one or more unknown electrical values within the electrical system.

In particular, the system obtains data defining multiple graphs, each graph representing a respective electrical system topology (202). In some cases, data defining the graphs can include one or more unknown electrical values within the electrical system. In some cases, the electrical system represented by the graph can be a real-world electrical power grid, and the electrical system topology can be a topology of the real-world electrical power grid.

The graph representing the electrical system topology can include multiple nodes and edges. Each node can represent a bus in the electrical system and can be associated with respective node features. Each edge in the graph can be defined by a nodal admittance matrix that corresponds to a number of buses in the electrical system. Furthermore, each edge in the graph can connect a pair of nodes in the graph, can be associated with respective edge features, and can represent a conductor in the electrical system that connects a pair of buses represented by the pair of nodes. In some cases, one or more of the nodes in the graph can represent different bus types in the electrical system, where the bus types can include: a swing bus, a generator, and a load. In some cases, the node features associated with each node can include a voltage magnitude and a voltage angle associated with the bus in the electrical system represented by the node. The edge features associated with each edge can include a current associated with the conductor in the electrical system represented by the edge.

The system obtains, for each electrical system topology and from an electrical simulation system, simulation results indicating an electrical behavior of the respective electrical system topology (204). In some cases, the simulation results indicating the electrical behavior of the respective electrical system topology can be generated using a ground-truth electrical simulation system (e.g., a powerflow simulation).

The system trains the machine learning model to predict electrical behaviors of electrical systems (206). In particular, the system can apply data defining each graph as input to the machine learning model to obtain respective output inferences. Then, the system can adjust parameters of the machine learning model responsive to comparisons between the output inferences with simulation results of corresponding electrical system topologies.

In some cases, the machine learning model can be a graph neural network. The system can train the graph neural network by updating the graph at each of one or more update iterations. Specifically, at each update iteration, the system can use the graph neural network to process data defining the graph in accordance with a set of graph neural network parameters to update a current node representation of each node in the graph and a current edge representation of each edge in the graph. After the updating, the system can process the respective current node representation for each node in the graph to generate a respective final feature corresponding to each node in the graph. Furthermore, the system can process the current edge representation for each edge in the graph to generate a respective final feature corresponding to each edge in the graph. Based on the respective final feature corresponding to each node in the graph and the respective final feature corresponding to each edge in the graph, the system can generate the respective output inferences that represent one or more unknown electrical values within the electrical system.

FIG. 3 is a flow diagram of an example process 300 for performing simulations of electrical behaviors of an electrical system. For convenience, the process 300 is described as being performed by a system of one or more computers located in one or more locations, e.g., the electrical simulation system 100 in FIG. 1.

The system can use a graph neural network to process a graph representing an electrical system to infer, from the graph, one or more unknown electrical values within the electrical system (302). As described above with reference to FIG. 1, the graph representing the electrical system can include multiple nodes and edges, each node in the graph can represent a bus in the electrical system, and each edge in the graph can connect a pair of nodes in the graph and can represent a conductor in the electrical system that connects a pair of buses represented by the pair of nodes. The system can update the graph at each of one or more update iterations to infer the one or more unknown electrical values within the electrical system for each of the one or more update iterations.

Specifically, as described above with reference to FIG. 1, the system can update the graph using the graph neural network. In particular, the system can update the representations of the nodes and edges in the graph, while leaving the topology of the graph unchanged. At each update iteration, the graph neural network can process data defining the graph in accordance with a set of graph neural network parameters to generate an updated node representation of each node in the graph for a current update iteration and an updated edge representation of each edge in the graph for the current update iteration. Then, the system can infer values for one or more variables, or features, within the electrical system for the current update iteration based on the updated node representation of each node in the graph and the updated edge representation for each edge in the graph.

In some cases, the system can generate and save a data file for each update iteration that includes the predicted values for one or more variables, or features, of electrical components of the electrical system for a respective update iteration. Each update iteration can represent, e.g., a time step in the evolution of the electrical behavior of the electrical system.

The system can compile the one or more unknown electrical values within the electrical system inferred for each of the one or more update iterations with simulation results representing an electrical behavior of the electrical system over a time period generated by an electrical simulation system (304). For example, the system can compile the data file generated for a particular update iteration, e.g., as described above, with a data file that includes the simulation results generated by the electrical simulation system for a corresponding simulation time step. By compiling the data files in this manner, the system described in this specification can enhance the accuracy of simulation results performed by any electrical simulation system, even if such system performs simulations based on an electrical system model that includes missing, or incomplete, data.

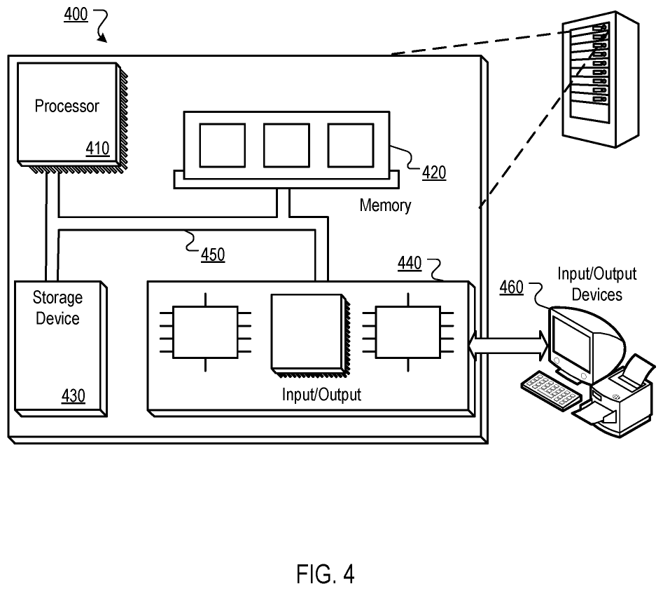

FIG. 4 is a block diagram of an example computer system 400 that can be used to perform operations described previously. The system 400 includes a processor 410, a memory 420, a storage device 430, and an input/output device 440. Each of the components 410, 420, 430, and 440 can be interconnected, for example, using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 can include, for example, a hard disk device, an optical disk device, a storage device that is shared over a network by multiple computing devices (for example, a cloud storage device), or some other large capacity storage device.

The input/output device 440 provides input/output operations for the system 400. In one implementation, the input/output device 440 can include one or more network interface devices, for example, an Ethernet card, a serial communication device, for example, and RS-232 port, and/or a wireless interface device, for example, and 802.11 card. In another implementation, the input/output device 440 can include driver devices configured to receive input data and send output data to other input/output devices, for example, keyboard, printer and display devices 460. Other implementations, however, can also be used, such as mobile computing devices, mobile communication devices, and set-top box television client devices.

Although an example processing system has been described in FIG. 4, implementations of the subject matter and the functional operations described in this specification can be implemented in other types of digital electronic circuitry, or in computer software, firmware, or hardware, including the structures disclosed in this specification and their structural equivalents, or in combinations of one or more of them.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which can also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program can, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what can be claimed, but rather as descriptions of features that can be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features can be described above as acting in certain combinations and even initially be claimed as such, one or more features from a claimed combination can in some cases be excised from the combination, and the claimed combination can be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing can be advantageous.

What is claimed is:

1. A method for training a machine learning model, the method comprising:
training the machine learning model to process a graph that represents an electrical system to infer, from the graph, one or more unknown electrical values within the electrical system, comprising:
obtaining data defining a plurality of graphs, each graph representing a respective electrical system topology;
obtaining, for each electrical system topology and from an electrical simulation system, simulation results indicating an electrical behavior of the respective electrical system topology; and
training the machine learning model to predict electrical behaviors of electrical systems including by applying data defining each graph as input to the machine learning model to obtain respective output inferences and adjusting parameters of the machine learning model responsive to comparisons between the output inferences with simulation results of corresponding electrical system topologies.

2. The method of claim 1, wherein the simulation results indicating the electrical behavior of the respective electrical system topology are generated using a ground-truth electrical simulation system.

3. The method of claim 1, wherein data defining the plurality of graphs includes one or more unknown electrical values within the electrical system.

4. The method of claim 1, wherein the electrical system represented by the graph is a real-world electrical power grid, and wherein the electrical system topology is a topology of the real-world electrical power grid.

5. The method of claim 1, wherein the graph that represents the electrical system comprises a plurality of nodes and a plurality of edges, wherein:
(i) each node represents a bus in the electrical system and is associated with respective node features, and
(ii) edges in the graph are defined by a nodal admittance matrix that corresponds to a number of buses in the electrical system, each edge in the graph connects a pair of nodes in the graph, is associated with respective edge features, and represents a conductor in the electrical system that connects a pair of buses represented by the pair of nodes.

6. The method of claim 5, wherein obtaining data defining a plurality of graphs, each graph representing a respective electrical system topology comprises, for each graph of the plurality of graphs:
obtaining data defining an admittance matrix; and
assigning an edge between a pair of nodes in the graph based on values specified by the admittance matrix.

7. The method of claim 6, wherein one or more of the nodes in the graph represent different bus types in the electrical system, and wherein the bus types include: a swing bus, a generator, and a load.

8. The method of claim 6, wherein the node features associated with each node that represents a respective bus in the electrical system include one or more of: a voltage magnitude, a voltage angle, an active power, and a real power, and wherein the edge features associated with each edge include a current associated with the conductor in the electrical system represented by the edge.

9. The method of claim 1, wherein the machine learning model is a graph neural network, and wherein training the machine learning model to predict the electrical behaviors of the electrical system by applying the data defining each graph as the input to the machine learning model to obtain the respective output inferences comprises, for each graph representing the respective electrical system topology:
updating the graph at each of one or more update iterations, comprising, at each update iteration:
processing data defining the graph using the graph neural network in accordance with a set of graph neural network parameters to update a current node representation of each node in the graph and a current edge representation of each edge in the graph.

10. The method of claim 9, further comprising:
after the updating, processing the respective current node representation for each node in the graph to generate a respective final feature corresponding to each node in the graph, and processing the current edge representation for each edge in the graph to generate a respective final feature corresponding to each edge in the graph; and
based on the respective final feature corresponding to each node in the graph and the respective final feature corresponding to each edge in the graph, generating the respective output inferences that represent one or more unknown electrical values within the electrical system.

11. A system comprising:
one or more computers; and
one or more storage devices communicatively coupled to the one or more computers, wherein the one or more storage devices store instructions that, when executed by the one or more computers, cause the one or more computers to perform operations for training a machine learning model, the operations comprising:
training the machine learning model to process a graph that represents an electrical system to infer, from the graph, one or more unknown electrical values within the electrical system, comprising:
obtaining data defining a plurality of graphs, each graph representing a respective electrical system topology;
obtaining, for each electrical system topology and from an electrical simulation system, simulation results indicating an electrical behavior of the respective electrical system topology; and
training the machine learning model to predict electrical behaviors of electrical systems including by applying data defining each graph as input to the machine learning model to obtain respective output inferences and adjusting parameters of the machine learning model responsive to comparisons between the output inferences with simulation results of corresponding electrical system topologies.

12. One or more non-transitory computer storage media storing instructions that when executed by one or more computers cause the one or more computers to perform operations for training a machine learning model, the operations comprising:
training the machine learning model to process a graph that represents an electrical system to infer, from the graph, one or more unknown electrical values within the electrical system, comprising:
obtaining data defining a plurality of graphs, each graph representing a respective electrical system topology;
obtaining, for each electrical system topology and from an electrical simulation system, simulation results indicating an electrical behavior of the respective electrical system topology; and
training the machine learning model to predict electrical behaviors of electrical systems including by applying data defining each graph as input to the machine learning model to obtain respective output inferences and adjusting parameters of the machine learning model responsive to comparisons between the output inferences with simulation results of corresponding electrical system topologies.
